(19) United States
(12) Patent Application Publication
(10) Pub. No.: US 2008/0254355 A1
(43) Pub. Date: Oct. 16, 2008

(54) NONAQUEOUS ELECTROLYTE SECONDARY BATTERY

(76) Inventors: Yoshiyuki MURAOKA, Osaka (JP); Naoyuki WADA, Osaka (JP); Hajime NISHINO, Nara (JP); Shinji KASAMATSU, Osaka (JP)

Correspondence Address: MCDERMOTT WILL & EMERY LLP, 600 13TH STREET, NW, WASHINGTON, DC, 20005-3096, US

(21) Appl. No.: 12/100,265

(22) Filed: Apr. 9, 2008

(30) Foreign Application Priority Data
Apr. 11, 2007 (JP) 2007-103972

(51) Int. Cl. H01M 10/36; H01M 4/02; H01M 2/16

(52) U.S. Cl. 429/129; 429/122; 429/209

(57) ABSTRACT

A lithium ion secondary battery includes a positive electrode, a negative electrode, a porous insulating layer and a nonaqueous electrolyte. The porous insulating layer is provided between the positive electrode and the negative electrode and contains a material which does not have a shutdown function. Each of the positive electrode and the negative electrode includes an expandable element.

### BACKGROUND OF THE INVENTION

1. Field of the Invention

The present invention relates to nonaqueous electrolyte secondary batteries and a method for manufacturing the nonaqueous electrolyte secondary batteries. In particular, it relates to a technology associated with safety of lithium ion secondary batteries.

2. Description of Related Art

With the rapid spread of portable and wireless electronic devices in recent years, there is a growing demand for use of small and lightweight secondary batteries having high energy density as driving power sources for these electronic devices.

Typical secondary batteries that meet the demand are nonaqueous electrolyte secondary batteries. A nonaqueous electrolyte secondary battery includes a positive electrode, a negative electrode, a separator and a nonaqueous electrolyte. The positive electrode includes a positive electrode active material supported on a positive electrode collector and capable of electrochemically reacting with lithium ions (e.g., lithium cobalt composite oxide). The negative electrode includes a negative electrode active material supported on a negative electrode collector. In particular, the negative electrode active material may be an active material such as lithium metal, a lithium alloy or a lithium intercalation compound based on carbon as a host substance (the host substance is a substance capable of absorbing and desorbing lithium ions). The polyethylene separator is provided between the positive and negative electrodes such that it supports the nonaqueous electrolyte and prevents a short circuit from occurring between the positive and negative electrodes. The nonaqueous electrolyte may be an aprotic organic solution dissolving therein lithium salt such as LiClO₄ or LiPF₆.

For the manufacture of such a lithium ion secondary battery, the positive and negative electrodes are shaped into a thin film sheet or foil, respectively. Then, the positive and negative electrodes are stacked or wound in a spiral with the polyethylene separator interposed therebetween to obtain a power generating element. The power generating element is placed in a battery case made of stainless steel-plated or nickel-plated iron or aluminum and the nonaqueous electrolyte is poured into the battery case. Then, the battery case is sealed with a lid fixed thereon.

When the lithium ion secondary battery is overcharged or the short circuit (internal or external) occurs, the temperature of the lithium ion secondary battery increases. If the temperature of the lithium ion secondary battery exceeds the melting point of polyethylene (about 110° C.), the polyethylene separator is melted and the positive and negative electrodes are brought into contact. As a result, large current flows between the positive and negative electrodes. This is very dangerous because the lithium ion secondary battery may cause fire or smoke in some cases.

Under these circumstances, it has been proposed to provide the lithium ion secondary battery with a device for interrupting current when the temperature increases (current interrupting device: abbreviated as CID). In general, gas is generated in the lithium ion secondary battery with the temperature rise and the gas generation raises the pressure in the lithium ion secondary battery. The CID is configured to sense the pressure rise in the lithium ion secondary battery. When the pressure in the lithium ion secondary battery increases, the CID detects that the temperature of the lithium ion secondary battery has increased and interrupts the current flow.

Nevertheless, when the battery case is broken, the hermeticity of the lithium ion secondary battery becomes insufficient. In such a case, the CID cannot properly sense the pressure rise in the lithium ion secondary battery. Further, if an impact such as a drop impact is given to the lithium ion secondary battery, a CID failure may possibly occur. If the CID does not work properly, the current interruption is not carried out when the temperature of the lithium ion secondary battery increases. Therefore, the battery safety is cannot be ensured.

As insurance against the CID failure, according to Japanese Unexamined Patent Publication No. 2006-147569, a porous ceramic layer which does not melt at high temperature is used instead of the polyethylene separator. As the porous ceramic layer does not melt even if the temperature of the lithium ion secondary battery increases, a contact area between the positive and negative electrodes is less likely to increase if the short circuit occurs and large current is prevented from flowing between the positive and negative electrodes.

According to Japanese Unexamined Patent Publication No. 2003-31208, thermally expandable material powder which causes volume expansion at a temperature not lower than the predetermined temperature is dispersed in an active material layer. With this configuration, electrical conduction between the active material particles and that between the active material and the collector are interrupted when the temperature of the battery exceeds the predetermined temperature.

### SUMMARY OF THE INVENTION

As described above, the temperature of the lithium ion secondary battery increases when the lithium ion secondary battery is overcharged and when the internal or external shirt circuit occurs in the lithium ion secondary battery. It is said that the rate of the temperature rise of the lithium ion secondary battery varies depending on the causes of the temperature rise, i.e., the overcharge, external and internal short circuits.

When the lithium ion secondary battery is overcharged or the external short circuit occurs, the temperature of the lithium ion secondary battery increases gradually. More specifically, when the lithium ion secondary battery is overcharged, i.e., when the lithium ion secondary battery is charged up to a voltage above the normal application range, there are still several minutes to several hours before the temperature of the lithium ion secondary battery reaches or exceeds a level at which thermal runaway starts (140° C. in general) after the lithium ion secondary battery falls into an abnormal state. In some cases, even if the charge is continued for several hours or more after the lithium ion secondary battery falls into the abnormal state, the temperature of the battery is still lower than the temperature at which the thermal runaway starts.

When the internal short circuit occurs in the lithium ion secondary battery, on the other hand, the temperature of the lithium ion secondary battery increases abruptly. More specifically, the temperature of part of the battery where the internal short circuit occurred reaches or exceeds the temperature at which the thermal runaway starts within a second after the occurrence of the internal short circuit. The temperature of the whole part of the lithium ion secondary battery also reaches or exceeds the temperature at which the thermal runaway starts within several seconds after the occurrence of the internal short circuit.

The porous ceramic layer disclosed by Japanese Unexamined Patent Publication No. 2006-147569 does not melt or contract even if the temperature of the lithium ion secondary battery increases. Therefore, a contact area between the positive and negative electrodes is less likely to increase. However, the porous ceramic layer does not have a current interrupting function, i.e., the current is not interrupted even when the temperature of the lithium ion secondary battery increases and the temperature rise cannot be stopped. Therefore, the technique disclosed by Japanese Unexamined Patent Publication No. 2006-147569 does not always ensure the safety of the lithium ion secondary battery.

The thermally expandable material powder disclosed by Japanese Unexamined Patent Publication No. 2003-31208 is able to increase its resistance value along with the increase in temperature. Therefore, the resistance value between the positive and negative electrodes is increased to prevent the flow of the large current. However, it is difficult for the thermally expandable material powder to expand along with an abrupt temperature rise. Therefore, the temperature of the lithium ion secondary battery may further increase before the thermally expandable material powder expands and the lithium ion secondary battery may fall into the abnormal state. Thus, the technique disclosed by Japanese Unexamined Patent Publication No. 2003-31208 does not always ensure the safety of the lithium ion secondary battery.

Under these circumstances, the present invention is directed to ensure the safety of the battery both in the cases of the overcharge and the short circuit.

A nonaqueous electrolyte secondary battery of the present invention includes a positive electrode, a negative electrode and a nonaqueous electrolyte supported between the positive electrode and the negative electrode, wherein a porous insulating layer containing a material which does not have a shutdown function is provided between the positive electrode and the negative electrode and an expandable element containing a thermally expandable material is provided in at least one of the positive electrode and the negative electrode.

When a polyethylene separator is used as the porous insulating layer and the temperature of the nonaqueous electrolyte secondary battery increases, the separator is widely melted away from the short circuited part. As a result, a contact area between the positive and negative electrodes increases. Therefore, large current flows in the short circuited part between the positive and negative electrodes and thermal runaway occurs in the nonaqueous electrolyte secondary battery.

On the other hand, if the porous insulating layer contains the material that does not have the shutdown function as described above, the loss of the porous insulating layer is prevented even if the short circuit occurs in the nonaqueous electrolyte secondary battery. As a result, the contact area between the positive and negative electrodes is prevented from increasing and the large current is prevented from flowing therebetween. This slows the rate of the temperature rise in the nonaqueous electrolyte secondary battery when the short circuit occurs.

When the nonaqueous electrolyte secondary battery is overcharged or external short circuit occurs and the temperature of the battery exceeds a predetermined temperature, the expandable element expands to interrupt the current flow. Therefore, the charge is finished before the thermal runaway occurs in the nonaqueous electrolyte secondary battery.

In the nonaqueous electrolyte secondary battery of the present invention, it is preferable that the positive electrode includes a conductive positive electrode collector and a positive electrode material mixture layer formed on a surface of the positive electrode collector and contains lithium composite oxide and the negative electrode includes a conductive negative electrode collector and a negative electrode material mixture layer formed on a surface of the negative electrode collector and contains a negative electrode active material capable of electrochemically absorbing and desorbing lithium ions.

In a preferred embodiment described below, the expandable element is provided on at least one of an interface between the positive electrode collector and the positive electrode material mixture layer and an interface between the negative electrode collector and the negative electrode material mixture layer. In this case, the expandable element may be dispersed on at least one of the interfaces or cover at least one of the interfaces.

In a preferred embodiment described below, the expandable element is provided in at least one of the positive electrode material mixture layer and the negative electrode material mixture layer. In this case, the expandable element may be dispersed in at least one of the electrode material mixture layers or provided as a layer in at least one of the electrode material mixture layers.

The material which does not have the shutdown function is a metal compound in a preferred embodiment described below or a heat resistant polymer in another preferred embodiment described below.

If the material which does not have the shutdown function is the metal compound, the porous insulating layer preferably includes a metal compound layer containing the metal compound and an intermediate layer provided between the metal compound layer and at least one of the positive electrode material mixture layer and the negative electrode material mixture layer.

In the metal compound layer, metal compound particles are bonded together by a binder or the like. Therefore, the surface of the metal compound layer is uneven. The uneven surface of the metal compound layer is planarized by providing the intermediate layer as described above. Further, the provision of the intermediate layer makes it possible to prevent the metal compound layer from falling off the electrode plate when the electrode group is wound in a spiral.

If the material which does not have the shutdown function is the metal compound, it is preferably at least one metal oxide selected from the group consisting of magnesium oxide, silicon dioxide, aluminum oxide and zirconium oxide.

The porous insulating layer of the nonaqueous electrolyte secondary battery of the present invention is preferably bonded to at least one of the positive electrode material mixture layer and the negative electrode material layer.

In a preferred embodiment described below, the thermally expandable material is expandable graphite.

### BRIEF DESCRIPTION OF THE DRAWINGS

FIG. 1 is a vertical sectional view illustrating the structure of a lithium ion secondary battery.

FIG. 2 is a sectional view illustrating the structure of an electrode group of Embodiment 1.

FIG. 3 is a graph illustrating a general temperature characteristic of a positive electrode active material.

FIG. 4 is a sectional view illustrating the structure of an electrode group of Embodiment 2.

FIG. 5 is a sectional view illustrating the structure of an electrode group of Embodiment 3.

FIG. 6 is a sectional view illustrating the structure of an electrode group of a modification of Embodiment 3.

FIG. 7 is a sectional view illustrating the structure of an electrode group of Embodiment 4.

FIG. 8 is an enlargement of a region VIII shown in FIG. 7.

### DETAILED DESCRIPTION OF THE INVENTION

In advance of the explanation of embodiments of the present invention, how the inventors have developed the present invention will be described below.

As mentioned above, there is a demand for a nonaqueous electrolyte secondary battery (lithium ion secondary battery) which remains safe even if the overcharge or the short circuit occurs.

To meet the demand, the inventors of the present invention have made a study on the material of the porous insulating layer. As a result, they have found that a lithium ion secondary battery including a polyethylene separator as the porous insulating layer (hereinafter referred to as a “conventional lithium ion secondary battery”) may fall into a significantly dangerous state in some cases when an internal short circuit occurs in the battery. The inventors' finding will be explained before the explanation of the embodiments of the invention.

It has been known that the conventional lithium ion secondary battery falls into a dangerous state due to the melting of the separator when the internal short circuit occurs in the conventional lithium ion secondary battery. More specifically, when the internal short circuit occurs in the conventional lithium ion secondary battery, the temperature of the short circuited part instantly exceeds the melting point of polyethylene. Therefore, the separator starts to melt widely from the short circuited part. As a result, large short circuit current flows near the short circuited part and the temperature increases in the whole part of the conventional lithium ion secondary battery. Thus, the battery falls into the dangerous state.

The inventors of the present invention have found for the first time that the polyethylene separator is reacted with oxygen to generate heat once the temperature of the conventional lithium ion secondary battery reaches around 400° C. due to the melting of the separator. In other words, when the internal short circuit occurs in the conventional lithium ion secondary battery, heat is generated by the separator itself in addition to Joule heat associated with the short circuit current in the internal short-circuited part. The heat generated by the separator is not negligible and occupies about ⅓ of the total heat generated in the lithium ion secondary battery in some cases. That is, the provision of the polyethylene separator for ensuring the safety of the lithium ion secondary battery may impair the safety of the battery. Accordingly, the use of the polyethylene separator as the porous insulating layer is not preferable. The inventors has reached a conclusion that the separator is preferably made of a material having a melting point higher than that of polyethylene or a material which does not melt or contract even when the temperature of the lithium ion secondary battery increases.

In consideration of the case where the lithium ion secondary battery is overcharged or the external short circuit occurs in the battery, the lithium ion secondary battery is preferably configured such that the current is interrupted when the temperature increases gradually.

Based on the above-described results, the material having a melting point higher than that of polyethylene or the material which does not melt or contract even when the temperature of the lithium ion secondary battery increases is used as the porous insulating layer and the lithium ion secondary battery is configured such that the current is interrupted when the temperature increases gradually. Thus, the present invention has been achieved.

Hereinafter, embodiments of the present invention will be described in detail with reference to the drawings, but the present invention is not limited to the following embodiments. In the embodiments, substantially the same components may be indicated by the same reference numerals to omit the explanation.

### Embodiment 1

Embodiment 1 of the present invention takes a lithium ion secondary battery as an example of the nonaqueous electrolyte secondary battery. The structure of the lithium ion secondary battery will be explained below.

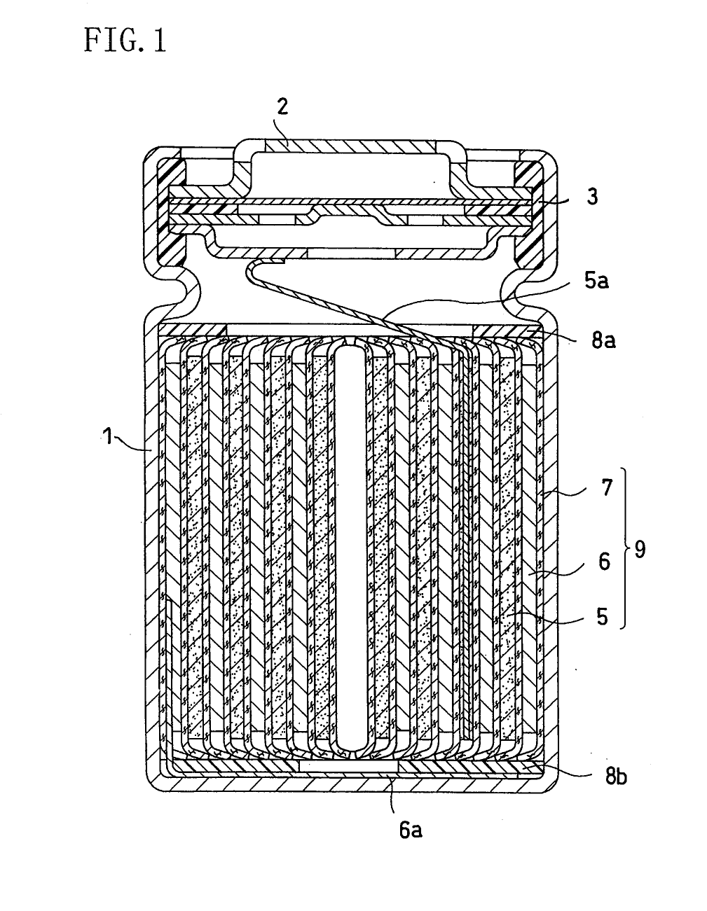

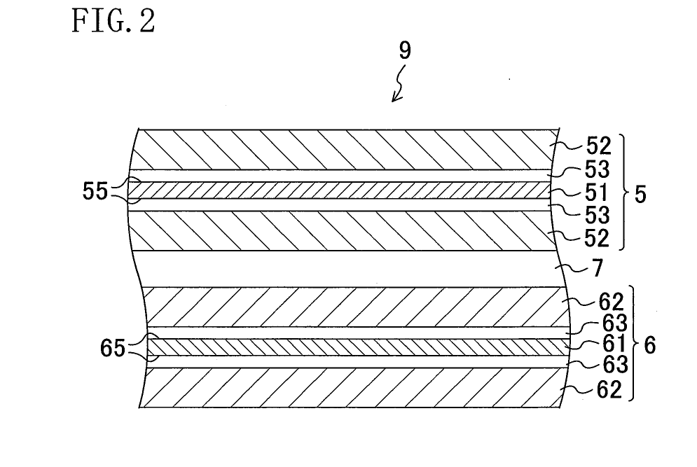

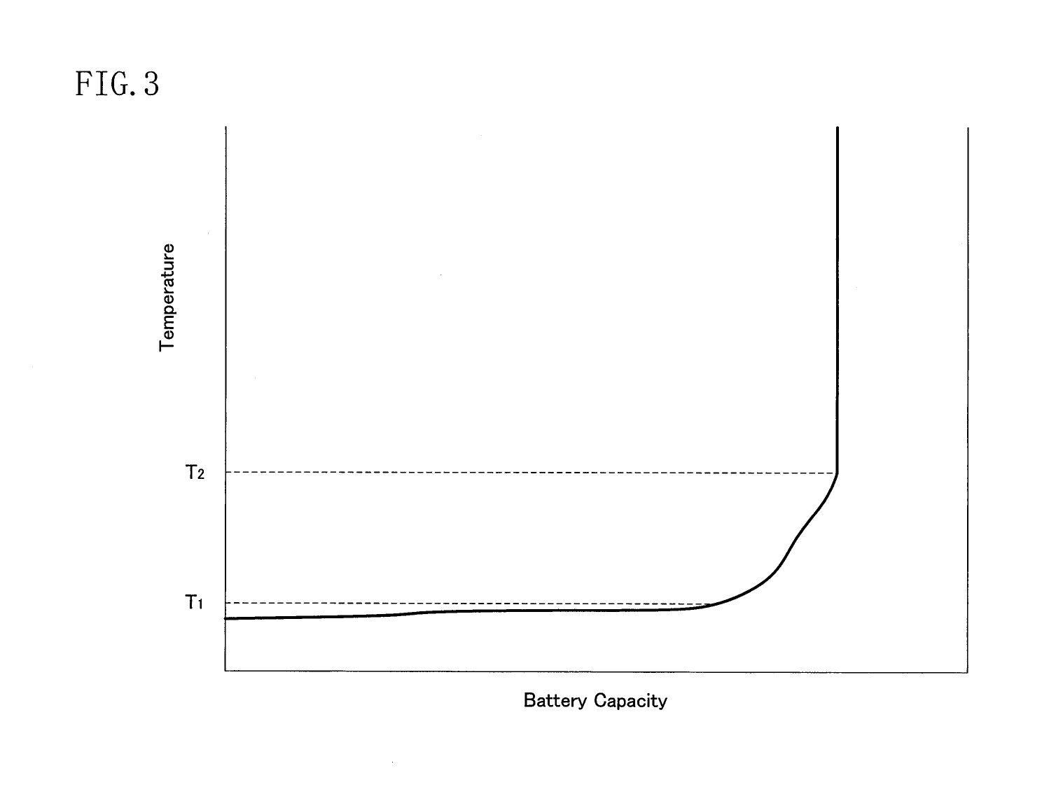

FIG. 1 is a vertical sectional view illustrating the structure of the lithium ion secondary battery of the present embodiment. FIG. 2 is a sectional view illustrating the structure of an electrode group 9 included in the lithium ion secondary battery of the present embodiment. FIG. 3 is a graph illustrating a general temperature characteristic of a positive electrode active material.

The lithium ion secondary battery of the present embodiment includes, as shown in FIG. 1, a stainless steel battery case 1 and an electrode group 9 placed in the battery case 1.

The battery case 1 has an opening la at the top thereof. A sealing plate 2 is crimped to the opening la with a gasket 3 interposed therebetween. The opening la is closed by crimping the sealing plate 2.

The electrode group 9 includes a positive electrode 5, a negative electrode 6 and a porous insulating layer 7. The positive electrode 5 and the negative electrode 6 together with the porous insulating layer 7 sandwiched between are wound in a spiral. A top insulator 8a and a bottom insulator 8b are arranged at the top and the bottom of the electrode group 9, respectively.

An aluminum positive electrode lead 5a is connected to the positive electrode 5 at one end and to the sealing plate 2 which also serves as a positive electrode terminal at the other end. A nickel negative electrode lead 6a is connected to the negative electrode 6 at one end and to the battery case 1 which also serves as a negative electrode terminal at the other end.

The positive electrode 5 includes, as shown in FIG. 2, a positive electrode collector 51, positive electrode material mixture layers 52 and expandable elements 53. The positive electrode collector 51 is a conductive plate. The positive electrode material mixture layers 52 are supported on the positive electrode collector 51 and contain a positive electrode active material (not shown, e.g., lithium composite oxide). The positive electrode material mixture layers 52 preferably contain a binder or a conductive agent in addition to the positive electrode active material. Each of the expandable elements 53 is provided between the positive electrode collector 51 and the positive electrode material mixture layer 52 to cover an interface 55 between the positive electrode collector 51 and the positive electrode material mixture layer 52. The negative electrode 6 includes a negative electrode collector 61, negative electrode material mixture layers 62 and expandable elements 63. The negative electrode collector 61 is a conductive plate. The negative electrode material mixture layers 62 are supported on the negative electrode collector 61 and contain a negative electrode active material (not shown). The negative electrode material mixture layers 62 preferably contain a binder in addition to the negative electrode active material. Each of the expandable elements 63 is provided between the negative electrode collector 61 and the negative electrode material mixture layer 62 to cover an interface 65 between the negative electrode collector 61 and the negative electrode material mixture layer 62.

Hereinafter, the porous insulating layer 7 and the expandable elements 53 and 63 will be explained in detail.

First, the porous insulating layer 7 is provided between the positive electrode material mixture layer 52 and the negative electrode material mixture layer 62. The porous insulating layer 7 is preferably adhered to one of the positive and negative electrode material mixture layers 52 and 62, more preferably to both of the positive and negative electrode material mixture layers 52 and 62. The porous insulating layer 7 keeps the positive and negative electrodes 5 and 6 insulated and supports a nonaqueous electrolyte (not shown). Therefore, the porous insulating layer 7 preferably has high ion permeability, a certain mechanical strength and a certain insulation property. Specific examples thereof are a thin microporous film, woven fabric or nonwoven fabric.

The porous insulating layer 7 contains a material which does not have a shutdown function.

The shutdown function is a function of interrupting a current flow by blocking the pores in the porous insulating layer. More specifically, when a polyethylene separator is used as the porous insulating layer and the temperature of the lithium ion secondary battery exceeds the melting point of polyethylene, the polyethylene separator is melted to block the pores in the porous insulating layer. Accordingly, the polyethylene separator has the shutdown function.

In the present embodiment, the material which does not have the shutdown function is a material which does not have the function of interrupting the current. In other words, it is a material which does not melt or contract and keeps working as the porous insulating layer 7 even if the temperature of the lithium ion secondary battery increases (130° C. or higher, e.g., 300° C.). With use of such a material, the porous insulating layer 7 does not melt away even if the temperature of the lithium ion secondary battery increases. Therefore, a contact area between the positive and negative electrodes 5 and 6 is less likely to increase. In this specification, the material that does not melt or contact in the lithium ion secondary battery even at high temperature is referred to as “high heat resistant material”.

Examples of the high heat resistant material include heat resistant polymers and metal compounds.

The heat resistant polymer is a polymer capable of withstanding continuous use at a high temperature not lower than 300° C. Therefore, the heat resistant polymer is able to insulate the positive and negative electrodes 5 and 6 at least at a temperature less than 300° C. Examples of the heat resistant polymer may include aramid (aromatic polyamide), polyimide, polyamide-imide, polyphenylene sulfide, polyether-imide, polyethylene terephthalate, polyether nitrile, polyether ether ketone, polybenzimidazole and polyallylate.

The metal compound may be metal oxide, metal nitride and metal sulfide, which are considered to be resistant up to a temperature not lower than 1000° C. Therefore, the metal compound is able to insulate the positive and negative electrodes 5 and 6 at least at a temperature less than 1000° C. Examples of the metal oxide used as the metal compound may include alumina (aluminum oxide; Al₂O₃), titania (titanium oxide; TiO₂), zirconia (zirconium oxide; ZrO₂), magnesia (magnesium oxide; MgO), zinc oxide (ZnO) and silica (silicon oxide; SiO₂).

The porous insulating layer 7 may be made of the heat resistant polymer only, the metal compound only or both of the heat resistant polymer and the metal compound. For the following two reasons, it is preferable that the porous insulating layer 7 contains the metal compound. One of the reasons is that the porous insulating layer 7 containing the metal compound is more heat resistant than the porous insulating layer 7 which does not contain the metal compound and keeps insulation between the positive and negative electrodes 5 and 6 at a higher temperature. Another reason is that the metal compound is solid even at high temperature and therefore minimizes the propagation of fire, if it happens in the lithium ion secondary battery. In order to obtain the effect of the use of the metal compound, magnesia (MgO), silica (SiO₂), aluminum oxide (Al₂O₃) or zirconium oxide (ZrO₂) is preferably used as the metal compound. If the porous insulating layer 7 contains the metal compound, metal compound particles are preferably bonded to each other by a binder.

The porous insulating layer 7 may contain other material than the heat resistant polymer, the metal compound and the binder. The other material than the heat resistant polymer, the metal compound and the binder is not particularly limited as long as it does not impair the function of the porous insulating layer 7. If a material which melts or contracts at around 100° C. is contained as the other material in addition to the heat resistant polymer, the metal compound and the binder, the content of the other material is preferably controlled to be very small such that it cannot function as the porous insulating layer as described in Embodiment 4 mentioned below.

Next, the expandable elements 53 and 63 will be explained.

Each of the expandable elements 53 and 63 contains a thermally expandable material (not shown). Therefore, when the temperature of the lithium ion secondary battery gradually increases up to or exceed a predetermined temperature (e.g. 80° C.), the expandable elements 53 and 63 expand.

In general, the lithium ion secondary battery shows electron conductivity between the positive electrode active material and the positive electrode collector 51, as well as between the negative electrode active material and the negative electrode collector 61. Therefore, the lithium ion secondary battery is capable of charging and discharging. When the temperature of the lithium ion secondary battery of the present embodiment gradually increases, the expandable element 53 expands to increase the distance between the positive electrode collector 51 and the positive electrode material mixture layer 52, thereby insulating the positive electrode collector 51 and the positive electrode material mixture layer 52 from each other. At the same time, the expandable element 63 expands to increase the distance between the negative electrode collector 61 and the negative electrode material mixture layer 62, thereby insulating the negative electrode collector 61 and the negative electrode material mixture layer 62 from each other. Therefore, if the temperature of the lithium ion secondary battery of the present embodiment gradually increases, the electron conduction between the positive electrode active material and the positive electrode collector 51 and that between the negative electrode active material and the negative electrode collector 61 are blocked. Thus, even if the temperature of the lithium ion secondary battery gradually increases, the large current is prevented from flowing.

The thermally expandable material may be a well-known thermally expandable material. In particular, a material which expands at a temperature from 80° C. to 130° C., both inclusive, is preferably used. For example, expandable graphite is preferably used. Expandable graphite contains a sulfate group (—SO₄) or a chlorine group (—Cl) in a crystal lattice of graphite. At a high temperature (e.g., 80° C. or higher), the sulfate or chlorine group turns into gas to expand graphite. When graphite expands, a conductive path is lengthened and electronic resistance is increased.

When the temperature of the lithium ion secondary battery is not very high (e.g., lower than 80° C.), expandable graphite functions as a conductor. Therefore, if expandable graphite is selected as the thermally expandable material in the lithium ion secondary battery of the present embodiment, the increase of the resistance between the positive and negative electrodes 5 and 6 during charge or discharge is prevented even if the expandable elements 53 and 63 are provided. For the above-described reasons, use of expandable graphite as the thermally expandable material makes it possible to ensure the safety of the lithium ion secondary battery without deteriorating the performance of the lithium ion secondary battery (charge or discharge performance).

If the thermally expandable material expands at a temperature lower than 80° C., the lithium ion secondary battery may no longer be able to perform normal operation (charge or discharge) depending on its state of use. The temperature of the lithium ion secondary battery may increase up to around 80° C. during charge or discharge. Therefore, if the thermally expandable material expands at a temperature lower than 80° C., the electron conduction in the positive and negative electrodes 5 and 6 is interrupted during normal operation. Further, if the thermally expandable material expands only after the temperature exceeds 130° C., thermal runaway may possibly occur in the lithium ion secondary battery before the expansion. In either case, the safety of the lithium ion secondary battery is not ensured.

The lower limit of the temperature range is not limited to 80° C. and it may be 70° C. or 90° C. When the positive electrode active material shows a temperature characteristic as shown in FIG. 3, the lower limit is preferably placed between a temperature at which gradual temperature rise starts (T₁) and a temperature at which abrupt temperature rise begins (T₂). Likewise, the upper limit of the temperature range is not limited to 130° C. and it may be 120° C. or 140° C. When the positive electrode active material has a temperature characteristic as shown in FIG. 3, the upper limit is preferably established such that the temperature at which the abrupt temperature rise begins (T₂) lies between the lower limit and the upper limit of the temperature range. Further, the upper limit is preferably set at a temperature lower than the temperature at which the thermal runaway of the lithium ion secondary battery begins.

The amount of the thermally expandable material to be applied to one surface of the collector is preferably 0.5 cm³/m² to 5 cm³/m², both inclusive. If the application amount of the thermally expandable material is less than 0.5 cm³/m², it is not preferable because the effect of the application of the thermally expandable material may not be obtained and the safety of the lithium ion secondary battery is not ensured. If the application amount of the thermally expandable material exceeds 5 cm³/m², on the other hand, the effect of the application of the thermally expandable material is obtained. However, it is not preferable because the battery performance (discharge performance, battery capacity and energy density) may be impaired.

Each of the expandable elements 53 and 63 may be prepared by bonding thermally expandable material particles with a binder or may contain other material than the thermally expandable material. The other material than the thermally expandable material is not particularly limited. However, it is not preferable to use a material which may hinder the expansion of the thermally expandable material.

The expandable elements 53 and 63 are considered to be irreversible. That is, once the thermally expandable material expands when the temperature of the lithium ion secondary battery increases up to or exceeds 80° C., it does not contract and remains expanded even if the temperature of the battery decreases to less than 80° C. Thus, according to the present embodiment, the lithium ion secondary battery cannot return to the usable state once it falls into the abnormal state. Therefore, the lithium ion secondary battery of the present embodiment is always a safe lithium ion secondary battery which has never fallen into the abnormal state.

Hereinafter, the operation of the lithium ion secondary battery of the present embodiment will be explained.

Under the normal operation state, the temperature of the lithium ion secondary battery of the present embodiment does not greatly increase. At this time, the expandable elements 53 and 63 do not expand. If expandable graphite is selected as the thermally expandable material, the expandable elements 53 and 63 function as conductors. Therefore, even if the expandable elements 53 and 63 are provided, the resistance between the positive and negative electrodes 5 and 6 is less likely to increase in the normal operation.

When the lithium ion secondary battery of the present embodiment is overcharged, the temperature of the lithium ion secondary battery increases. Since the temperature slowly increases, the thermally expandable material expands with the temperature increase. The expansion makes it possible to interrupt the electron conduction between the positive electrode collector 51 and the positive electrode active material and that between the negative electrode collector 61 and the negative electrode active material. Further, if expandable graphite is used as the thermally expandable material, it is converted from conductive to insulative when expanded. Therefore, the resistance value between the positive and negative electrodes 5 and 6 is increased. Thus, in the lithium ion secondary battery of the present embodiment, the charging is finished with safety when the battery is overcharged.

In the case of an external short circuit, the temperature of the lithium ion secondary battery gradually increases. Therefore, the charge or discharge of the lithium ion secondary battery of the present embodiment can be finished with safety even if the external short circuit occurs.

When the internal short circuit occurs in the lithium ion secondary battery of the present embodiment, the temperature of the lithium ion secondary battery abruptly increases. Even if the abrupt temperature rise occurs, the porous insulating layer 7 does not melt away. Therefore, the contact area between the positive and negative electrodes 5 and 6 is less likely to increase. As a result, the charge or discharge of the lithium ion secondary battery of the present embodiment can be finished with safety even if the internal short circuit occurs.

As described above, the presence of the porous insulating layer 7 in the lithium ion secondary battery of the present embodiment makes it possible to keep the insulation between the positive and negative electrodes 5 and 6 even when the abrupt temperature rise occurs. On the other hand, when the temperature increases gradually, the presence of the expandable elements 53 and 63 makes it possible to interrupt the electron conduction in the positive and negative electrodes 5 and 6. Thus, regardless of whether the temperature rise occurs abruptly or gradually, the positive and negative electrodes 5 and 6 are kept insulated.

Hereinafter, materials of the positive electrode 5, negative electrode 6, porous insulating layer 7 and nonaqueous electrolyte will be described in order.

As to the positive and negative electrodes 5 and 6, materials for the positive and negative electrode collectors 51 and 61 and the positive and negative electrode material mixture layers 52 and 62 are not particularly limited and any known material can be used.

Each of the positive and negative electrode collectors 51 and 61 may be made of a long porous or nonporous conductive substrate. The positive electrode collector 51 may be made of a stainless steel plate, an aluminum plate or a titanium plate. The negative electrode collector 61 may be a stainless steel plate, a nickel plate or a copper plate. The thicknesses of the positive and negative electrode collectors 51 and 61 are not particularly limited. Their thicknesses are preferably 1 μm to 500 μm, both inclusive, more preferably 5 μm to 20 μm, both inclusive. If the thicknesses of the positive and negative electrode collectors 51 and 61 are in the above-described range, the strength of the positive and negative electrodes 5 and 6 is maintained and the weight of the positive and negative electrodes 5 and 6 is reduced.

Examples of the positive electrode active material may include LiCoO₂, LiNiO₂, LiMnO₂, LiCoNiO₂, LiCoMO_{z}, LiNiMO_{z}, LiMn₂O₄, LiMnMO₄, LiMePO₄ and Li₂MePO₄F (wherein M is at least one of Na, Mg, Sc, Y, Mn, Fe, Co, Ni, Cu, Zn, Al, Cr, Pb, Sb and B), as well as compounds obtained by substituting one of the elements of these lithium-containing compounds with a different element. The positive electrode active material may be surface-treated with metal oxide, lithium oxide or a conductive agent, e.g., by hydrophobization.

Among the above-listed examples, nickel-containing lithium composite oxide is preferably used as the positive electrode active material. This is because the nickel-containing lithium composite oxide has high electric capacitance and the use of the nickel-containing lithium composite oxide as the positive electrode active material makes it possible to achieve a high capacity lithium ion secondary battery.

It has been known that the nickel-containing lithium composite oxide is thermally unstable. However, even if the lithium composite oxide lacking thermal stability is used as the positive electrode active material, the stability of the positive electrode active material is ensured for the following reasons.

When the conventional lithium ion secondary battery falls in an abnormal state and its temperature increases, the polyethylene separator is melted and large current flows. As a result, the temperature of the lithium ion secondary battery further increases. That is, if the conventional lithium ion secondary battery using the nickel-containing lithium composite oxide as the positive electrode active material falls into the abnormal state, the positive electrode active material becomes unstable.

In contrast, when the lithium ion secondary battery of the present embodiment falls in the abnormal state, the insulation between the positive and negative electrodes is maintained and the large current is prevented from flowing. Therefore, even if the lithium ion secondary battery of the present embodiment using the nickel-containing lithium composite oxide as the positive electrode active material falls into the abnormal state, the positive electrode active material remains stable.

Examples of the negative electrode active material may include metal, metal fiber, a carbon material, oxide, nitride, a tin compound, a silicon compound and various alloys. Examples of the carbon material may include various natural graphites, coke, partially-graphitized carbon, carbon fiber, spherical carbon, various artificial graphites and amorphous carbon. Since the simple substances such as silicon (Si) and tin (Sn), the silicon compound and the tin compound have high capacitance density, it is preferable to use them as the negative electrode active material. Examples of the silicon compound may include SiOₓ (0.05<x<1.95) and a silicon alloy, a silicon compound and a silicon solid solution obtained by substituting part of Si with at least one of the elements selected from the group consisting of B, Mg, Ni, Ti, Mo, Co, Ca, Cr, Cu, Fe, Mn, Nb, Ta, V, W, Zn, C, N and Sn. The tin compound may be, for example, Ni₂Sn₄, Mg₂Sn, SnOₓ (0<x<2), SnO₂ or SnSiO₃. One of the examples of the negative electrode active material may be used solely or two or more of them may be used in combination.

The positive electrode material mixture layer 52 preferably contains a binder or a conductive agent in addition to the lithium composite oxide. The negative electrode material mixture layer 62 preferably contains a binder in addition to the negative electrode active material.

Examples of the binder may include PVDF (poly(vinylidene fluoride)), polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber and carboxymethyl cellulose. The binder may be a copolymer of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid and hexadiene. A mixture of these materials may also be used.

Examples of the conductive agent may include graphites such as natural graphite and artificial graphite, carbon blacks such as acetylene black (AB), Ketjen black, channel black, furnace black, lamp black and thermal black, conductive fibers such as carbon fiber and metal fiber, metal powders such as carbon fluoride and aluminum, conductive whiskers such as zinc oxide and potassium titanate, conductive metal oxides such as titanium oxide and organic conductive materials such as a phenylene derivative.

The ratio of the active material, conductive agent and binder in the positive electrode material mixture layer 52 is not particularly limited and they may be contained in the known ratio in the positive electrode material mixture layer 52.

Now, the porous insulating layer 7 will be detailed. When metal oxide is used as the high heat resistant material and secondary particles are obtained by bonding primary particles with a binder, the filling factor of the metal oxide in the porous insulating layer 7 is reduced. As a result, the porosity of the porous insulating layer 7 increases, which gives high lithium ion permeability to the porous insulating layer 7. The secondary particles are preferably prepared by sintering or dissolving and recrystallizing part of the primary metal oxide particles. The secondary particles may be chain particles or layered particles. The dissolution and recrystallization process is a process of dissolving the metal oxide in a solvent and then recrystallizing it to bond the primary particles together. The diameter of the primary particle is preferably 0.01 μm to 0.5 μm, both inclusive. The size of the primary particle (diameter of a chain particle or width of a flake-like particle) can be measured using an SEM (scanning electron microscope).

The secondary particles can be manufactured by various methods, such as a chemical method of dissolving the primary particles entirely or partially using a chemical agent and then recrystallizing them or a physical method of applying external pressure to the primary particles. Among them, a simple method is to raise the temperature close to the melting point of the primary particles and then bond them together. If the secondary particles are prepared by this method, binding force between the primary particles in a partially melting state is preferably set high enough not to crush the primary particles while melting and stirring them to prepare paste. If the bulk density of the particles increases in the dissolution and recrystallization process, the strength of the porous insulating layer is reduced. Therefore, the primary particles preferably have low bulk density.

The binder for binding the high heat resistance material particles is preferably a polymer resin. The polymer resin belongs to acrylates and preferably contains a methacrylate polymer or a methacrylate copolymer. More specifically, examples of the polymer resin may include PVDF, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber and carboxymethyl cellulose. The binder may be a copolymer of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid and hexadiene. A mixture of two or more of these materials may also be used.

The thickness of the porous insulating layer 7 is generally 10 μm to 300 μm, both inclusive. However, the thickness is preferably 10 μm to 40 μm, both inclusive, more preferably 15 μm to 30 μm, both inclusive, still more preferably 10 μm to 25 μm, both inclusive. If a thin microporous film is used as the porous insulating layer 7, the thin microporous film may be a monolayer film made of a single material, a multilayer film made of a single material or a composite film made of two or more materials. The porosity of the porous insulating layer 7 is preferably 30% to 70%, both inclusive, more preferably 35% to 60%, both inclusive. The porosity is the volume ratio of the pores to the porous insulating layer.

The nonaqueous electrolyte may be a liquid nonaqueous electrolyte, a gelled nonaqueous electrolyte or a solid electrolyte (solid polymer electrolyte).

The liquid nonaqueous electrolyte is prepared by dissolving an electrolyte (e.g., lithium salt) in a nonaqueous solvent. The gelled nonaqueous electrolyte contains a nonaqueous electrolyte and a polymer material supporting the nonaqueous electrolyte. The polymer material supporting the nonaqueous electrolyte may be, for example, polyvinylidene fluoride, polyacrylonitrile, polyethylene oxide, polyvinyl chloride, polyacrylate or polyvinylidene fluoride hexafluoropropylene.

A known nonaqueous solvent can be used as the nonaqueous solvent for dissolving the electrolyte. The nonaqueous solvent is not particularly limited and examples thereof may include cyclic carbonate, chain carbonate and cyclic carboxylate. Cyclic carbonate may be propylene carbonate (PC) and ethylene carbonate (EC). The chain carbonate may be diethyl carbonate (DEC), ethylmethyl carbonate (EMC) and dimethyl carbonate (DMC). The cyclic carboxylate may be γ-butyrolactone (GBL) and γ-valerolactone (GVL). One of the examples of the nonaqueous solvent may be used solely or two or more of them may be used in combination.

Examples of the electrolyte to be dissolved in the nonaqueous solvent may include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates and imidates. Examples of the borates include bis(1,2-benzene diorate(2-)-O,O′)lithium borate, bis(2,3-naphthalene diorate(2-)-O,O′)lithium borate, bis(2,2′-biphenyl diorate(2-)-O,O′)lithium borate and bis(5-fluoro-2-orate-1-benzenesulfonic acid-O,O′)lithium borate. Examples of the imidates include lithium bistrifluoromethanesulfonimide ((CF₃SO₂)₂NLi), lithium trifluoromethanesulfonate nonafluorobutanesulfonimide (LiN(CF₃SO₂)(C₄F₉SO₂)) and lithium bispentafluoroethanesulfonimide ((C₂F₅SO₂)₂NLi). One of these electrolytes may be used solely or two or more of them may be used in combination.

The nonaqueous electrolyte may further contain, as an additive, a material which is decomposed on the negative electrode 6 and forms thereon a coating having high lithium ion conductivity for enhancing the charge-discharge efficiency. Examples of the additive having such a function may include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate (VEC) and divinylethylene carbonate. One of the additives may be used solely or two or more of them may be used in combination. Among the additives, at least one selected from the group consisting of vinylene carbonate, vinylethylene carbonate and divinylethylene carbonate is preferable. In the above-listed compounds, part of a hydrogen atom may be substituted with a fluorine atom. The amount of the electrolyte dissolved in the nonaqueous solvent is preferably 0.5 mol/m³ to 2 mol/m³, both inclusive.

The nonaqueous electrolyte may further contain a benzene derivative. The benzene derivative is decomposed during the overcharge and forms a coating on the electrode plate. As a result, the lithium ion secondary battery is inactivated. The benzene derivative preferably has a phenyl group and a cyclic compound group adjacent to the phenyl group. The cyclic compound group may preferably be a phenyl group, a cyclic ether group, a cyclic ester group, a cycloalkyl group or a phenoxy group. Examples of the benzene derivative may include cyclohexylbenzene, biphenyl and diphenyl ether. One of the benzene derivatives may be used solely or two or more of them may be used in combination. However, the content of the benzene derivative is preferably not higher than 10 vol % of the total volume of the nonaqueous solvent.

Hereinafter, a method for manufacturing the lithium ion secondary battery of the present embodiment will be described.

First, a thermally expandable material is provided on the surfaces of the positive electrode collector 51 and the surfaces of the negative electrode collector 61. The thermally expandable material may be provided by a known method. For example, a thermally expandable material, a binder and a solvent are mixed to prepare paste. The paste is applied to the surfaces of the positive electrode collector 51 and the surfaces the negative electrode collector 61 and then dried. In this way, the expandable elements 53 are formed on the both surfaces of the positive electrode collector 51 and the expandable elements 63 are formed on the both surfaces of the negative electrode collector 61.

Then, a positive electrode material mixture is provided on the expandable elements 53, while a negative electrode material mixture is provided on the expandable elements 63. The electrode material mixtures may be provided by a known method. For example, the positive electrode material mixture is provided by mixing a positive electrode material (containing a binder and a conductive material) and a positive electrode active material into a solvent to form a positive electrode material mixture slurry, applying the slurry on the surfaces of the expandable elements 53 and drying the slurry. Likewise, the negative electrode material mixture is provided by mixing a negative electrode material (containing a binder) and a negative electrode active material into a solvent to prepare a negative electrode material mixture slurry, applying the slurry on the surfaces of the expandable elements 63 and drying the slurry. In this way, the positive electrode material mixture layers 52 sandwiching the expandable elements 53, respectively, are provided on the surfaces of the positive electrode collector 51 to complete the positive electrode 5. Further, the negative electrode material mixture layers 62 sandwiching the expandable elements 63, respectively, are provided on the surfaces of the negative electrode collector 61 to complete the negative electrode 6.

Then, the positive and negative electrodes 5 and 6 are arranged to face each other and a porous insulating layer material is provided between the positive and negative electrodes 5 and 6. The porous insulating layer material may be provided by a known method such as dipping, spraying or printing. The dipping is performed by dipping the electrode plate into a solution mixture prepared by uniformly dispersing the porous insulating layer material and a binder into a solvent. The spraying is carried out by spraying the solution mixture onto the surface of the electrode material mixture layer. The printing is to print the solution mixture onto the entire surface of the electrode plate. It is preferable that the porous insulating layer material is adhered onto the surfaces of the positive electrode material mixture layer 52 and the negative electrode material mixture layer 62.

The positive and negative electrodes 5 and 6 bonded to each other are wound to obtain an electrode group and the obtained electrode group is placed in a battery case. Then, the nonaqueous electrolyte is poured into the battery case and the battery case is sealed. Thus, the lithium ion secondary battery of the present embodiment is obtained.

As described above, the lithium ion secondary battery of the present embodiment includes the porous insulating layer 7 and the expandable elements 53 and 63. Therefore, even when the internal or external short circuit occurs or the lithium ion secondary battery is overcharged, the safety of the lithium ion secondary battery is ensured.

### Embodiment 2

In Embodiment 2, the structure of the positive and negative electrodes is different from that of Embodiment 1. Hereinafter, the difference from Embodiment 1 will be described.

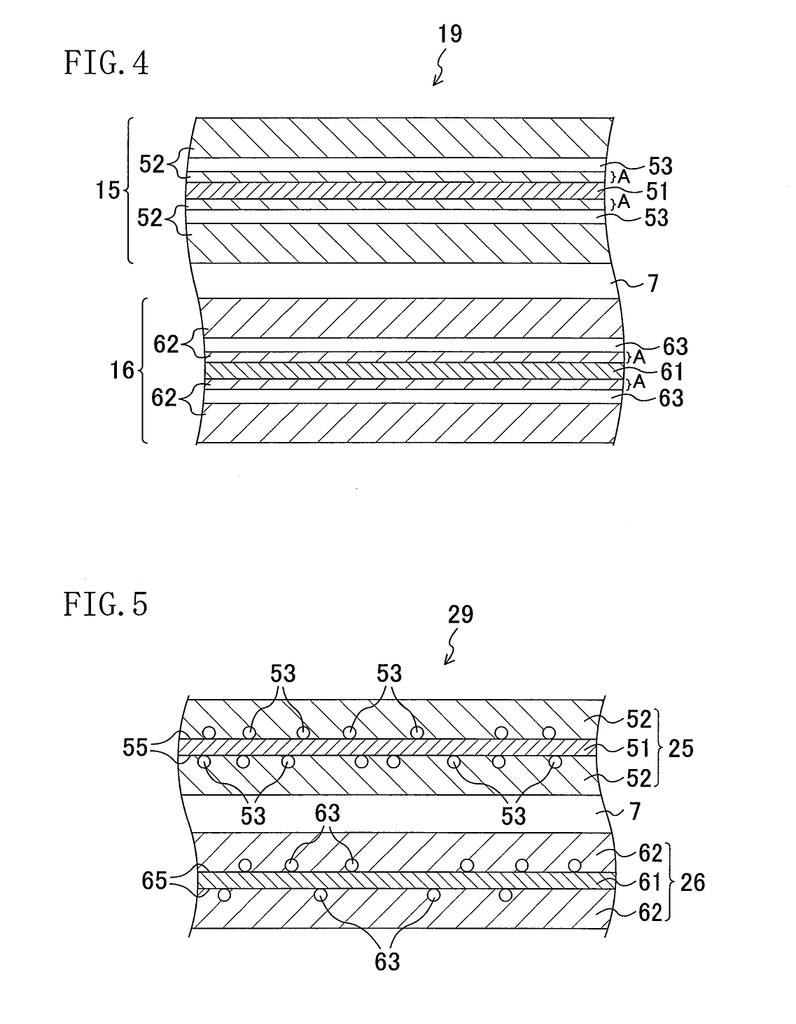

FIG. 4 is a sectional view illustrating the structure of an electrode group 19 of the present embodiment.

The electrode group 19 of the present embodiment includes a positive electrode 15, a negative electrode 16 and a porous insulating layer 7. As the electrode group 19 includes the porous insulating layer 7, the increase of the contact area between the positive and negative electrodes 15 and 16 is prevented even if the internal short circuit occurs in the lithium ion secondary battery.

The positive electrode 15 includes positive electrode material layers 52 formed on both surfaces of the positive electrode collector 51. An expandable element 53 in the form of a layer is provided in each of the positive electrode material layers 52. The negative electrode 16 includes negative electrode material layers 62 formed on both surfaces of the negative electrode collector 61. An expandable element 63 in the form of a layer is provided in each of the negative electrode material layers 62.

It is preferable that the expandable element 53 is provided in the positive electrode material layer 52 such that it extends substantially parallel to the positive electrode collector 51 and the expandable element 63 is provided in the negative electrode material layer 62 such that it extends substantially parallel to the negative electrode collector 61. The phrase “the expandable element 53 extends substantially parallel to the positive electrode collector 51” covers not only the expandable element 53 extending parallel to the positive electrode collector 51, but also the expandable element 53 slightly inclined with respect to the positive electrode collector 51 and the expandable element 53 provided to make the collector surface slightly irregular.

When the thus-configured lithium ion secondary battery is overcharged or external short circuit occurs in the lithium ion secondary battery, the temperature of the lithium ion secondary battery gradually increases and the expandable elements 53 and 63 expands with the temperature increase. As a result, electron conductivity in the positive and negative electrodes 15 and 16 is reduced and large current is prevented from flowing between the positive and negative electrodes 15 and 16.

In the present embodiment, the electron conduction between the positive electrode active material in region A and the positive electrode collector 51 may not be interrupted when the short circuit occurs. Therefore, it is preferable to reduce the region A as much as possible because the electron conduction in the positive electrode 15 is interrupted more effectively. It is most preferable that the region A is eliminated as in the battery of Embodiment 1. The same applies to the negative electrode 16.

As described above, the lithium ion secondary battery of the present embodiment provides the same effect as that of Embodiment 1.

### Embodiment 3

In Embodiment 3, the structure of the positive and negative electrodes is different from that of Embodiment 1. The difference from Embodiment 1 will be described below.

FIG. 5 is a sectional view illustrating the structure of an electrode group 29 of the present embodiment.

The electrode group 29 of the present embodiment includes a positive electrode 25, a negative electrode 26 and a porous insulating layer 7. As the electrode group 29 includes the porous insulating layer 7, the increase of the contact area between the positive and negative electrodes 25 and 26 is prevented even if the internal short circuit occurs in the lithium ion secondary battery.

The positive electrode 25 includes positive electrode material layers 52 formed on both surfaces of the positive electrode collector 51. Expandable elements 53 are dispersed on interfaces 55 between the positive electrode collector 51 and the positive electrode material mixture layers 52. Likewise, the negative electrode 26 includes negative electrode material mixture layers 62 formed on both surfaces of the negative electrode collector 61 and expandable elements 63 are dispersed on interfaces 65 between the negative electrode collector 61 and the negative electrode material mixture layers 62.

When the thus-configured lithium ion secondary battery is overcharged or external short circuit occurs in the lithium ion secondary battery, the temperature of the lithium ion secondary battery gradually increases and the expandable elements 53 and 63 expand with the temperature increase. As a result, electron flow paths in the positive and negative electrodes 25 and 26 are compressed.

As described above, the lithium ion secondary battery of the present embodiment provides the same effect as that obtained in Embodiment 1. As compared with Embodiment 1, the amount of the thermally expandable material is reduced. Therefore, the battery performance is improved and the cost is reduced.

The expandable elements 53 and 63 may be dispersed within the positive and negative electrode material layers 52 and 62, respectively, as described in the following modification.

### (Modification)

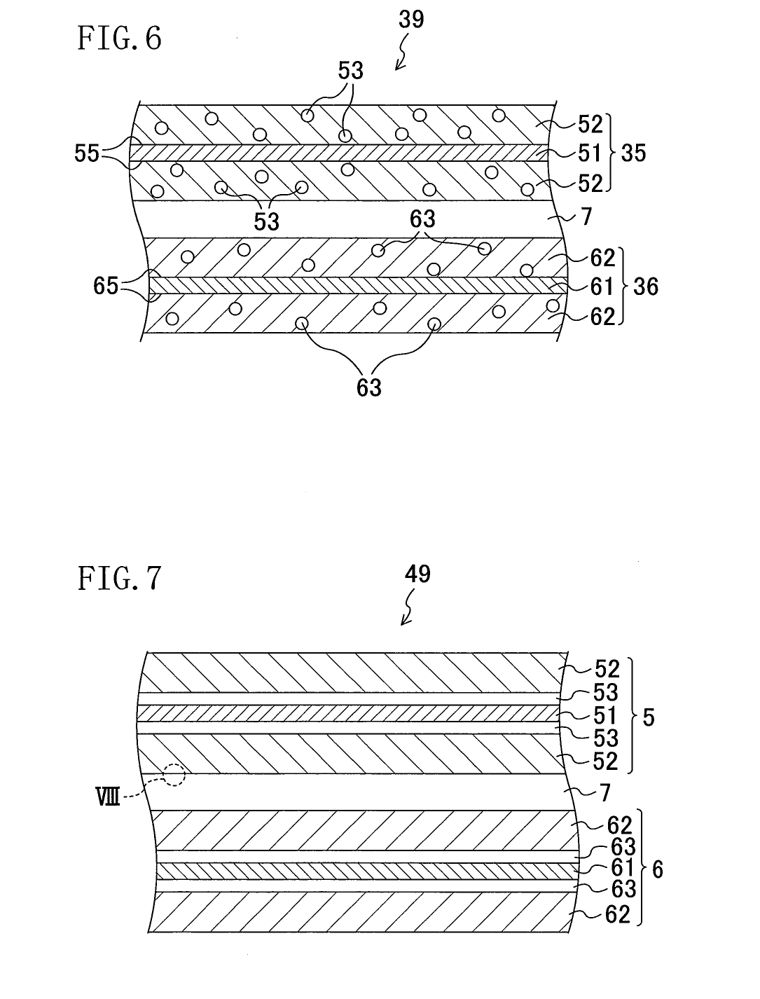

FIG. 6 is a sectional view illustrating the structure of an electrode group 39 of the present modification.

According to the present modification, the expandable elements 53 are dispersed in the positive electrode material mixture layers 52 and the expandable elements 63 are dispersed in the negative electrode material mixture layers 62.

When the lithium ion secondary battery of the present modification is overcharged or the external short circuit occurs in the lithium ion secondary battery, the temperature of the lithium ion secondary battery gradually increases and the expandable elements 53 and 63 expand. As a result, electron flow paths in the positive and negative electrodes 35 and 36 are compressed.

It is more preferable that the expandable elements 53 and 63 are dispersed on the interfaces 55 and 65 as described in Embodiment 3 than in the positive and negative electrode material mixture layers 52 and 62. The reason is as follows.

In order to interrupt the electron transfer in the positive and negative electrodes 35 and 36 of the battery of the present modification, it is preferable to provide the expandable elements 53 among the positive electrode active material particles and the expandable elements 63 among the negative electrode active material particles. Therefore, a large amount of the expandable elements 53 and 63 are required in the positive and negative electrode material mixture layers 52 and 62, respectively, and the cost of the lithium ion secondary battery increases.

Further, as the amount of the expandable elements 53 and 63 increases, the amount of the positive or negative electrode active material decreases. This may lead to deterioration of the performance of the lithium ion secondary battery.

On the other hand, the expandable elements 53 and 63 are provided on the interfaces 55 and 65, respectively, in the lithium ion secondary battery of Embodiment 3. Therefore, the amount of the expandable elements 53 and 63 is reduced as compared with that required in the present modification. As a result, the cost of the lithium ion secondary battery is reduced and the deterioration of the battery performance is less likely to occur.

### Embodiment 4

Embodiment 4 is different from Embodiment 1 in the structure of the porous insulating layer. Hereinafter, the difference from Embodiment 1 will be explained.

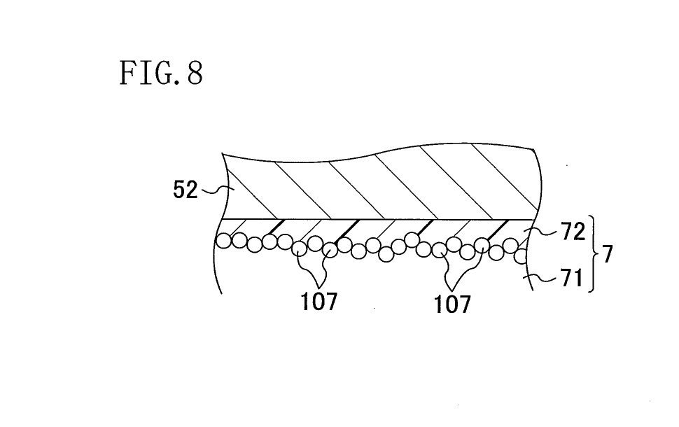

FIG. 7 is a sectional view illustrating the structure of an electrode group 49 of the present embodiment and FIG. 8 is sectional view showing an enlargement of a region VIII shown in FIG. 7.

The electrode group 49 of the present embodiment includes, just like the electrode group of Embodiment 1, a positive electrode 5, a negative electrode 6 and a porous insulating layer 37. The positive electrode 5 includes expandable elements 53 and the negative electrode 6 includes expandable elements 63. The porous insulating layer 37 includes a metal compound layer 71 containing metal compound particles 107 as the high heat resistant material and intermediate layers 72 formed on both surfaces of the metal compound layer 71. The intermediate layers 72 are omitted from FIG. 7 because they are very thin as compared with the electrode material mixture layers and the collectors.

The metal compound layer 71 is made of the metal compound particles 107 bonded to each other by a binder. Therefore, the surfaces thereof are uneven as shown in FIG. 8. The intermediate layers 72 are provided on the uneven surfaces, respectively, to planarize the surfaces of the porous insulating layer 37. That is, the intermediate layers 72 sandwich the metal compound layer 71. Therefore, as compared with the structure having no intermediate layers 72, the metal compound particles 107 are less likely to fall off the positive electrode material mixture layer 52 or the negative electrode material mixture layer 62 when the electrode group 49 is wound in a spiral. With the provision of the intermediate layers 72, the surfaces of the porous insulating layer 37 are planarized and the adhesion between the metal compound layer 71 and the positive electrode material mixture layer 52 or the negative electrode material mixture layer 62 is enhanced.

Each of the intermediate layers 72 may be a resin layer such as a polyethylene layer. If a resin having heat resistance to a temperature around 1 00C is used as the intermediate layers on the porous insulating layer 37, the resin generates heat when the temperature of the lithium ion secondary battery increases, thereby leading to further temperature rise as described in Embodiment 1. However, if the content of the intermediate layers 72 in the porous insulating layer 37 is kept small so that the intermediate layers do not function as the porous insulating layer 37 (5 μm or less in thickness), the heat generated by the intermediate layers 72, if any, is kept small. Therefore, remarkable temperature rise of the lithium ion secondary battery is prevented.

The porous insulating layer of the present embodiment may consist of a heat resistant polymer layer made of imide or the like and the intermediate layers provided on both surfaces thereof. The intermediate layer may be provided on one of the surfaces of the metal compound layer or one of the surfaces of the heat resistant polymer layer.

The shape of the metal compound particles 107 is not limited to that shown in FIG. 8.

### Other Embodiments

Embodiments 1 to 4 of the present invention may be configured as follows.

In Embodiments 1 and 3, the expandable element may be provided on the interface between the positive electrode collector and the positive electrode material mixture layer or the interface between the negative electrode collector and the negative electrode material mixture layer. In Embodiments 2 and 4, the expandable element may be provided in the positive electrode material mixture layer or the negative electrode material mixture layer. Further, the expandable element may be provided on the interface between the collector and the electrode material mixture layer and in the electrode material mixture layer.

The porous insulating layer may be made of a material having higher melting point than polyethylene, such as polypropylene. Even in this case, the lithium ion secondary battery of the present invention is able to show improved heat resistance as compared with conventional lithium ion secondary batteries.

The lithium ion secondary battery described above includes an electrode group wound in a spiral. However, the electrode group may have a layered structure including a plurality of electrode plates. Further, the cylindrical lithium ion secondary battery described above may be shaped flat.

### EXAMPLES

In the following examples, cylindrical lithium ion secondary batteries shown in FIG. 1 were manufactured and they were examined by a nail penetration test and an overcharge test.

### 1. Method for Manufacturing Lithium Ion Secondary Battery

### Example 1

### (Manufacture of Positive Electrode)

4 parts by weight of polyacrylic acid derivative (binder) and a proper quantity of N-methyl-2-pyrrolidone (abbreviated as NMP) (dispersion medium) were mixed into 100 parts by weight of expandable graphite (thermally expandable material) having an average particle diameter of 2 μm to obtain slurry (nonvolatile matter: 30 wt %). In this example, the mixture of the expandable graphite particles, the polyacrylic acid derivative and NMP was stirred using a medialess disperser named “CLEAR MIX (trade name)” manufactured by M-Technique until the expandable graphite particles, the polyacrylic acid derivative and NMP were uniformly dispersed.

Then, the slurry was applied to both surfaces of a 15 μm thick aluminum foil (positive electrode collector) using a gravure roll and dried at 120° C. such that the expandable graphite particles were dispersed on the surface of the positive electrode collector. The amount of expandable graphite dispersed on the surface of the positive electrode collector was 1 cm³/m² per surface.

Then, 1.7 parts by weight of polyvinylidene fluoride (PVDF) (binder) was dissolved in N-methyl-2-pyrrolidone (NMP) to prepare a binder solution, to which 1.25 parts by weight of acetylene black was mixed to prepare a conductive agent.

To the obtained conductive agent, 100 parts by weight of LiNi_{0.80}Co_{0.10}Al_{0.10}O₂ (positive electrode active material) was mixed to obtain positive electrode material mixture paste. The positive electrode material mixture paste was applied to the both surfaces of the 15 μm thick aluminum foil and dried. Then, the obtained product was rolled and cut. Thus, a positive electrode of 0.125 mm in thickness, 57 mm in width and 700 mm in length was obtained.

### (Manufacture of Negative Electrode)

First, mesophase microspheres were graphitized at a high temperature of 2800° C. (hereinafter abbreviated as mesophase graphite) to prepare a negative electrode active material. Then, 100 parts by weight of mesophase graphite, 2.5 parts by weight of BM-400B which is acrylic acid-modified SBR manufactured by ZEON Corporation (solid content: 40 parts by weight), 1 part by weight of carboxylmethyl cellulose and a proper quantity of water were stirred using a dual-arm kneader to prepare negative electrode material mixture paste. The negative electrode material mixture paste was then applied to both surfaces of a collector made of a 18 μm thick Cu foil, followed by drying and rolling. Thus, a 0.02 mm thick negative electrode was obtained.

Then, a porous insulating material was prepared. Specifically, 4 parts by weight of polyacrylic acid derivative (binder) and a proper quantity of NMP (dispersion medium) were mixed into 100 parts by weight of certain polycrystalline alumina particles to prepare insulating slurry containing 60 wt % of nonvolatile matter (porous insulting material).

The mixture of the polycrystalline alumina particles, the polyacrylic acid derivative and NMP was stirred using a medialess disperser named “CLEAR MIX (trade name)” manufactured by M-Technique to obtain the insulating slurry in which the polycrystalline alumina particles, the polyacrylic acid derivative and NMP were uniformly dispersed.

Then, the insulating slurry was applied to both surfaces of the negative electrode by gravure coating and dried with hot air of 120° C. at 0.5 m/sec. As a result, a 20 μm thick porous insulating layer was formed on the surfaces of the negative electrode. The electrode was then cut into the size of 59 mm in width and 750 mm in length and a lead tab for drawing current was welded thereto. Thus, an alumina-coated negative electrode was formed.

### (Preparation of Nonaqueous Electrolyte Solution)

To a solution mixture containing ethylene carbonate and dimethyl carbonate in the volume ratio of 1:3, 5 wt % of vinylene carbonate was added and LiPF₆ in a concentration of 1.4 mol/m³ was dissolved to obtain a nonaqueous electrolyte solution.

### (Preparation of Cylindrical Lithium Ion Secondary Battery)

The positive and negative electrodes were arranged such that alumina on the negative electrode surface was sandwiched between the positive and negative electrodes and they were wound together in a spiral to form an electrode group.

Then, insulators were arranged on the top and bottom of the electrode group, a negative electrode lead was welded to a battery case and a positive electrode lead was welded to a sealing plate having a safety valve operated by internal pressure. Then, the positive and negative electrode leads were contained in the battery case.

Further, the nonaqueous electrolyte solution was poured into the battery case under reduced pressure. Then, an opening end of the battery case was crimped to the sealing plate with a gasket interposed therebetween to complete the lithium ion secondary battery of Example 1.

The capacity of the obtained cylindrical lithium ion secondary battery was 2900 mAh. For the measurement of the battery capacity, the battery was charged up to 4.2 V at a constant current of 1.4 A, charged at a constant voltage of 4.2 V up to a current value of 50 mA and then discharged to 2.5 V at a constant current of 0.56 A in an environment of 25° C.

The lithium ion secondary battery of Example 1 was not provided with a PTC (positive temperature coefficient) thermistor and a CID.

### Example 2

A lithium ion secondary battery of Example 2 was completed in the same manner as Example 1 except that the alumina layer (porous insulating layer, 20 μm thick) was formed not on the negative electrode surface but on the positive electrode surface.

### Example 3

A lithium ion secondary battery of Example 3 was completed in the same manner as Example 1 except that a polypropylene separator (20 μm thick) was used in place of the alumina layer as the porous insulating layer.

### Example 4

A lithium ion secondary battery of Example 4 was completed in the same manner as Example 1 except that an aramid separator (20 μm thick) was used in place of the alumina layer as the porous insulating layer.

### Comparative Example 1

A lithium ion secondary battery of Comparative Example 1 was completed in the same manner as Example 1 except that a polyethylene separator (20 μm thick) was used in place of the alumina layer as the porous insulating layer.

### Comparative Example 2

A lithium ion secondary battery of Comparative Example 2 was completed in the same manner as Example 1 except that expandable graphite was not scattered on the surface of the positive electrode collector.

### Comparative Example 3

A lithium ion secondary battery of Comparative Example 3 was completed in the same manner as Example 1 except that expandable graphite was not scattered on the surface of the positive electrode collector and a polyethylene separator (20 μm thick) was used in place of the alumina layer as the porous insulating layer.

### 2. Evaluation of Lithium Ion Secondary Battery

### (Nail Penetration Test)

The lithium ion secondary batteries of Examples 1 to 4 and Comparative Examples 1 to 3 were examined by a nail penetration test.

First, the lithium ion secondary batteries were charged at a constant current of 1.45 A up to a voltage of 4.25 V. After the voltage reached 4.25 V, the batteries were charged at a constant voltage to a current of 50 mA.

Then, a nail of 2.7 mm in diameter was pierced in the middle of the lithium ion secondary battery at 5 mm/sec in the environments of 30° C., 45° C. and 60° C. and 300 mm/sec in the environment of 70° C. to examine whether smoke was generated from the lithium ion secondary battery, i.e., whether a safety valve of the lithium ion secondary battery was actuated and the smoke was generated in the lithium ion secondary battery.

### (Overcharge Test)

The lithium ion secondary battery was continuously charged at a constant current of 1.45 A to inspect a change in electrode temperature and observe the appearance of the lithium ion secondary battery. The upper limit voltage to be applied to the lithium ion secondary battery was 60 V. When the smoke was not observed from the lithium ion secondary battery, the maximum temperature was measured on the surface of the lithium ion secondary battery.

### 3. Results and Discussion

The results are shown in Table 1. The results of the nail penetration test are indicated in the column of the number of batteries that caused smoke and the results of the overcharge test are indicated in the overcharge column. In the column of the number of batteries that caused smoke, the denominator is the number of tested lithium ion secondary batteries and the numerator is the number of lithium ion secondary batteries that caused smoke. The temperature indicated in the overcharge column is the maximum temperature of the battery that did not cause smoke and symbol x indicates that the smoke occurred.

TABLE 1

| | | | Number of batteries that | | | | |
|---|---|---|---|---|---|---|---|
| | Porous | | caused smoke in | | | | |
| | Insulating | Expandable | nail penetration test | | | | |
| | layer material | element | 30° C. | 45° C. | 60° C. | 70° C. | Overcharge |
| Ex. 1 | Alumina adhered to | Provided | 0/5 | 0/5 | 0/5 | 0/5 | 115° C. |
| | negative electrode | | | | | | |
| | surface | | | | | | |
| Ex. 2 | Alumina adhered to | Provided | 0/5 | 0/5 | 0/5 | 0/5 | 115° C. |
| | positive electrode | | | | | | |
| | surface | | | | | | |
| Ex. 3 | PP | Provided | 0/5 | 0/5 | 2/5 | 5/5 | 115° C. |
| Ex. 4 | Aramid | Provided | 0/5 | 0/5 | 0/5 | 2/5 | 115° C. |
| Com. Ex. 1 | PE | Provided | 0/5 | 5/5 | 5/5 | 5/5 | 110° C. |
| Com. Ex. 2 | Alumina adhered to | Not | 0/5 | 0/5 | 0/5 | 0/5 | x |
| | negative electrode | provided | | | | | |
| | surface | | | | | | |
| Com. Ex. 3 | PE | Not | 0/5 | 5/5 | 5/5 | 5/5 | 110° C. |
| | | provided | | | | | |

As a result of the nail penetration test, it was observed that every lithium ion secondary battery including the polyethylene separator as the porous insulating layer (Comparative Examples 1 and 3) caused smoke in the environment of 45° C. That is, the safety of the lithium ion secondary batteries was not ensured.

On the other hand, the lithium ion secondary batteries using the alumina layer as the porous insulating layer (Examples 1 and 2 and Comparative Example 2), those using aramid as the porous insulating layer (Example 4) and those using polypropylene as the porous insulating layer (Example 3) did not cause smoke in any environments.

In the lithium ion secondary batteries of Examples 1 to 4 and Comparative Example 2, the nail was pierced at 5 mm/sec in an environment of 75° C. As a result, none of the batteries of Examples 1 and 2 and Comparative Example 2 caused smoke. This indicates that these lithium ion secondary batteries are remarkably heat resistant. On the other hand, some of the lithium ion secondary batteries of Examples 3 and 4 caused smoke. The number of the lithium ion secondary batteries of Example 4 that caused smoke was smaller than the number of the lithium ion secondary batteries of Example 3 that caused smoke. Therefore, it is confirmed that the porous insulating layer having higher heat resistance makes it possible to reduce the number of the batteries that cause smoke more efficiently and therefore ensures the safety of the lithium ion secondary batteries.

As a result of the overcharge test, the lithium ion secondary batteries provided with the expandable element (Examples 1 to 4 and Comparative Example 1) did not cause smoke. However, the lithium ion secondary batteries not provided with the expandable element (Comparative Example 2) caused smoke.

What is claimed is:

1. A nonaqueous electrolyte secondary battery comprising a positive electrode, a negative electrode and a nonaqueous electrolyte supported between the positive electrode and the negative electrode, wherein
a porous insulating layer containing a material which does not have a shutdown function is provided between the positive electrode and the negative electrode and
an expandable element containing a thermally expandable material is provided in at least one of the positive electrode and the negative electrode.

2. The nonaqueous electrolyte secondary battery of claim 1, wherein the positive electrode includes a conductive positive electrode collector and a positive electrode material mixture layer formed on a surface of the positive electrode collector and contains lithium composite oxide,
the negative electrode includes a conductive negative electrode collector and a negative electrode material mixture layer formed on a surface of the negative electrode collector and contains a negative electrode active material capable of electrochemically absorbing and desorbing lithium ions and
the expandable element is provided on at least one of an interface between the positive electrode collector and the positive electrode material mixture layer and an interface between the negative electrode collector and the negative electrode material mixture layer.

3. The nonaqueous electrolyte secondary battery of claim 1, wherein the positive electrode includes a conductive positive electrode collector and a positive electrode material mixture layer formed on a surface of the positive electrode collector and contains lithium composite oxide,
the negative electrode includes a conductive negative electrode collector and a negative electrode material mixture layer formed on a surface of the negative electrode collector and contains a negative electrode active material capable of electrochemically absorbing and desorbing lithium ions and
the expandable element is provided in at least one of the positive electrode material mixture layer and the negative electrode material mixture layer.

4. The nonaqueous electrolyte secondary battery of claim 1, wherein the material which does not have the shutdown function is a metal compound.

5. The nonaqueous electrolyte secondary battery of claim 4, wherein the porous insulating layer includes
a metal compound layer containing the metal compound and
an intermediate layer provided between the metal compound layer and at least one of the positive electrode material mixture layer and the negative electrode material mixture layer.

6. The nonaqueous electrolyte secondary battery of claim 4, wherein the metal compound is at least one metal oxide selected from the group consisting of magnesium oxide, silicon dioxide, aluminum oxide and zirconium oxide.

7. The nonaqueous electrolyte secondary battery of claim 1, wherein the material which does not have the shutdown function is a heat resistant polymer.

8. The nonaqueous electrolyte secondary battery of claim 1, wherein the porous insulating layer is bonded to at least one of the positive electrode material mixture layer and the negative electrode material mixture layer.

9. The nonaqueous electrolyte secondary battery of claim 1, wherein the thermally expandable material is expandable graphite.
